(19) United States
(12) Patent Application Publication
(10) Pub. No.: US 2011/0095669 A1
(43) Pub. Date: Apr. 28, 2011

(54) REFRIGERATOR VACUUM INSULATION APPLICATION

(76) Inventors: William T. Moon, Taylorsville, KY (US); William Brown, JR., Louisville, KY (US); Kenneth R. Davis, Louisville, KY (US)

(21) Appl. No.: 12/604,070

(22) Filed: Oct. 22, 2009

(51) Int. Cl. F25D 23/02; F25D 23/06; B23P 15/26

(52) U.S. Cl. 312/405; 312/406; 29/890.035

(57) ABSTRACT

A refrigerator wall has an outer shell an inner liner, a cavity formed by the outer shell and the inner liner, insulation filling the cavity, and a vacuum insulation panel positioned in the cavity such that at least one edge of the vacuum insulation panel is located in a substantially maximum volume of insulation.

### BACKGROUND OF THE INVENTION

The exemplary embodiments disclosed herein generally relate to insulated panels, and more particularly, to insulated panels for refrigerated compartments.

A refrigerator may include a number of walls forming a refrigerated compartment. The refrigerator walls may have insulation sandwiched between an outer shell and an inner liner and the inner liner may fit within the outer shell providing a recess for additional storage within the refrigerated compartment. The inner liner may include dike portions circumscribing the perimeter of the inner liner that project inward and the cavity between the inner liner and the outer shell may be filled with foamed-in-place insulation. Foamed in place insulation may generally be made of a polyurethane, and may be foamed into the cavity to fill in the space between the inner liner and outer shell.

Vacuum insulation panels may also be used in refrigerator applications. Vacuum insulation panels are generally constructed by encasing insulation material within a vacuum barrier and then partially evacuating the panel. At ambient temperature, the thermal conductivity of a vacuum panel may reach less than 0.003 W/mK, which represents an improvement of almost an order of magnitude over conventional insulation. However, vacuum insulation panels may suffer from thermal edge effects that may cause losses in thermal insulation efficiency. Depending on the composition of the vacuum barrier layer, energy may flow through the barrier layer around the insulation at the panel edges, creating a thermal short circuit that negates the insulating effect of the panel, and creating cold spots and condensation on the exterior of the refrigerated compartment.

### SUMMARY OF THE INVENTION

As described herein, the exemplary embodiments overcome one or more of the above or other disadvantages known in the art.

One aspect of the exemplary embodiments relates to a refrigerator wall having an outer shell, an inner liner, a cavity formed by the outer shell and the inner liner, insulation filling the cavity, and a vacuum insulation panel positioned in the cavity such that at least one edge of the vacuum insulation panel is located in a substantially maximum volume of insulation.

Another aspect of the exemplary embodiments relates to a refrigerator door having an outer door member and an inner door member, a cavity formed by the outer and inner door members, insulation filling the cavity, and a vacuum insulation panel positioned in the cavity with its edges located in areas of the cavity having a substantially maximum volume of insulation.

Still another aspect of the exemplary embodiments relates to a refrigerator having a wall having an outer shell an inner liner, a cavity formed by the outer shell and the inner liner, insulation filling the cavity, and a vacuum insulation panel positioned in the cavity such that at least one edge of the vacuum insulation panel is located in a substantially maximum volume of insulation.

Yet another aspect of the exemplary embodiments relates to a method of manufacturing a refrigerator wall including forming a cavity from an outer shell and inner liner, placing a vacuum insulation panel within the cavity, and filling the cavity with insulation, where the vacuum insulation panel is placed within the cavity so that edges of the vacuum insulation panel are surrounded by a maximum volume of insulation.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and that, unless otherwise indicated, they are merely intended to conceptually illustrate the structures and procedures described herein. In addition, any suitable size, shape or type of elements or materials could be used.

### BRIEF DESCRIPTION OF THE DRAWINGS

In the drawings:

FIG. 1 is a perspective view of a refrigerator in accordance with an exemplary embodiment;

FIG. 2 is a perspective view of a refrigerator door constructed in accordance with an exemplary embodiment;

FIG. 3 is a partial cross section view of the refrigerator door as seen along line segment 3-3A in FIG. 2;

FIG. 4A is a side cross section view of the refrigerator door as seen along line 3-3 in FIG. 2;

FIG. 4B is a top cross section view of the refrigerator door as seen along line 4-4 in FIG. 2;

FIG. 5 shows a top cross section view of a refrigerator case constructed in accordance with an exemplary embodiment; and

FIG. 6 shows a front cross section view of a refrigerator case constructed in accordance with an exemplary embodiment.

### DETAILED DESCRIPTION OF THE EXEMPLARY EMBODIMENTS OF THE INVENTION

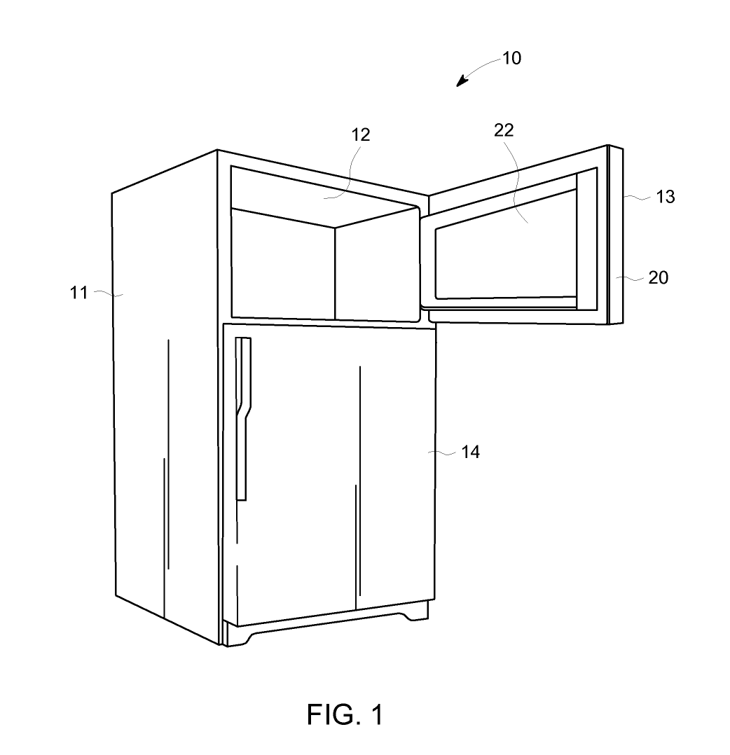

FIG. 1 illustrates a refrigerator in accordance with an exemplary embodiment. This example shows a top mount household refrigerator 10 having a case 11 with a freezer storage compartment 12 mounted above a fresh food storage compartment. Other refrigerator configurations can include, for example, the fresh food storage compartment mounted above the freezer storage compartment, the fresh food storage compartment and freezer storage compartment mounted side by side, a combination of stacked compartments and side-by-side compartments, or a single door refrigerator. It is contemplated that the disclosed embodiments are applicable to other types of refrigeration appliances and are not intended to be limited to be limited to any particular type or configuration of a refrigerator.

Each of the compartments may have an access opening that is normally closed by a door, in this embodiment shown as freezer door 13 or fresh food door 14. While the disclosed embodiments are described with respect to freezer door 13, it should be understood that they are also applicable to fresh food door 14, other refrigerator doors, other portions of the refrigerated compartments, and the refrigerator case 11. It should also be understood that refrigerator 10 is shown for illustrative purposes only and that the presently disclosed embodiments are also applicable to any suitable refrigerator.

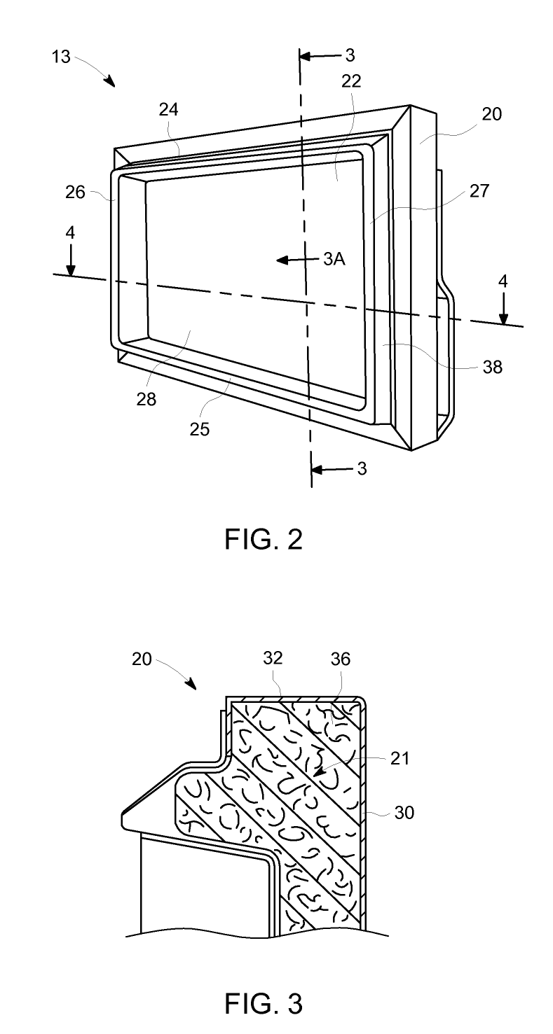

Referring to FIGS. 2 and 3, the freezer door assembly 13 includes an outer door member 20, an inner door member 22, and insulation 21. The outer door member 20 has a generally rectangular front panel 30 surrounded by a peripheral rim 32 that extends along the lateral edges of the panel 30 so as to entirely surround the perimeter of panel 30. The rim 32 projects generally perpendicular to panel 30 in a rearward direction, toward the cabinet 11 when the door assembly 13 is mounted in its normal closed position. The inner door member 22 includes upper and lower dike portions 24 and 25, respectively, extending horizontally which are interconnected by first and second dike portions 26 and 27 extending vertically and a central web 28. The inner door member 22 and the outer door member 20 define a cavity 36 that may be at least partially filled with insulation 21. The insulation may be foamed in place or any other suitable insulation.

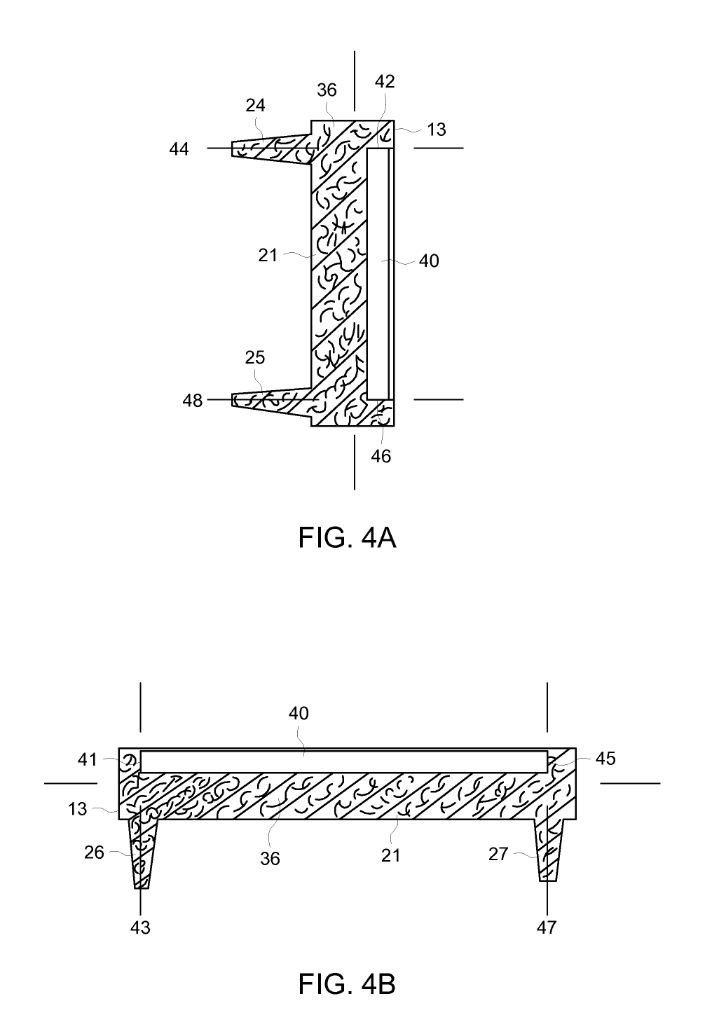

FIG. 4A is a side cross sectional view of door 13. In order to increase the resistance to heat transfer of the door 13, a vacuum insulation panel 40 may be placed within cavity 36 in accordance with the disclosed embodiments. In order to attenuate the edge effects of the vacuum insulation panel 40, the panel may be sized and oriented so that the edges 42, 46 of the panel may be located in areas of the cavity 36 having additional filled insulation 21. For example, the areas of the cavity 36 proximate the panel edges 42, 46 may have a larger volume than other areas of the cavity 36 and may hold more filled insulation 21 than other areas. The additional insulation 21 may serve as an additional insulative barrier to reduce the edge effects. In other embodiments, each edge 42, 46 of the panel may be located in an area of the cavity 36 having a substantially maximum volume of insulation compared to other areas of the cavity 36. In this embodiment, the edges of the panel may be centered with respect to the dike portions of the door in order to be so located. As shown in FIG. 4A, the dimensions of panel 40 may be selected so that top edge 42 of panel 40 may be aligned with a centerline 44 of upper dike portion 24 and bottom edge 46 of panel 40 may be aligned with a centerline 48 of lower dike portion 25. Referring to FIG. 4B, the dimensions of panel 40 have also been selected so that first side edge 41 of panel 40 may be aligned with a centerline 43 of first dike portion 26 and second side edge 45 of panel 40 may be aligned with a centerline 47 of second dike portion 27. Because the edges of panel 40 are aligned with the centerlines of the dikes 24, 25, 26, 27, the areas within cavity 36 proximate the edges 41, 42, 45, 46 may be larger and may also include more insulation than other areas of the cavity 36, for example, the portion of the cavity proximate the center of panel 40. The areas within cavity 36 proximate each of the edges 41, 42, 45, 46 may hold a maximum volume of insulation compared to other portions of the cavity. The maximum volumes among the proximate areas may vary due to tolerances related to manufacturing the components, assembling the components, the ability of the filled insulation 21 to wholly fill the cavity 36, and other factors.

Placing the panel 40 in the chamber 36 and surrounding it with insulation 21 may result in greatly reducing the thermal conductivity of the door 13. Sizing and orienting the panel 40 so that the edges 41, 42, 43, and 45 are aligned with the centers of the dike portions 24, 25, 26, and 27, respectively, thus locating the edges in areas having a substantially maximum volume of insulation 21, may further enhance the thermal characteristics of the door 13 by minimizing or attenuating any edge effects of the panels.

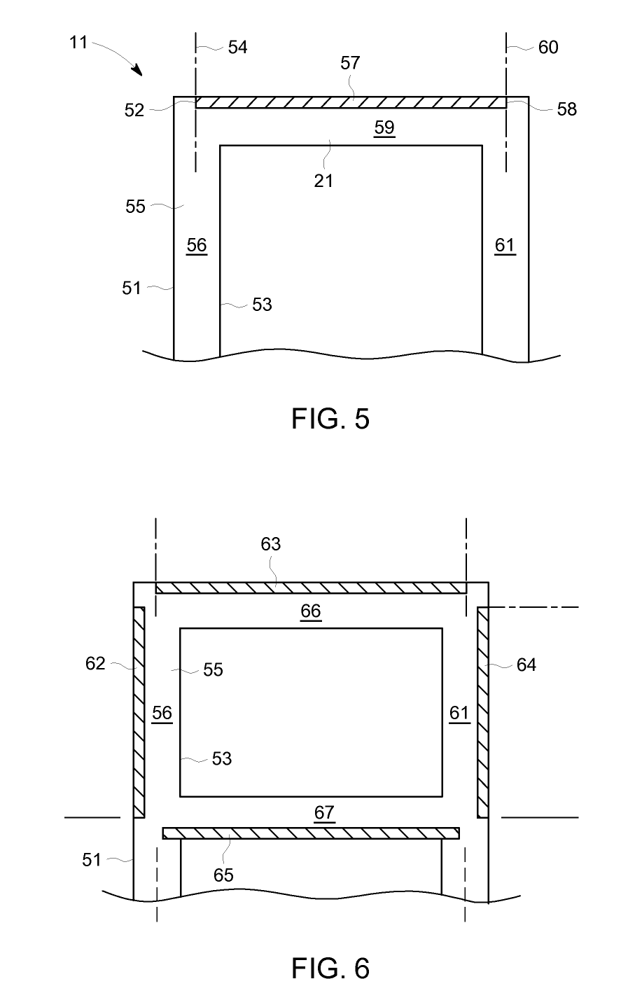

FIG. 5 shows a top cross section view of the refrigerator case 11. The refrigerator case 11 may include one or more walls 50 having an outer shell 51 and an inner liner 53. When assembled together the outer shell 51 and the inner liner 53 form a back portion 59 and first and second side portions 56 and 61, extending perpendicular to the back portion 59. The outer shell 51 and inner liner 53 also form a chamber 55 that may enclose the insulation 21. A vacuum insulation panel 57 may be placed within cavity 55 in the back portion 59 of the refrigerator case 11 and surrounded with insulation 21 according to the disclosed embodiments. In this embodiment, the edges of the vacuum insulation panel 57 may be centered with respect to the side portions of the refrigerator case 11. For example, the dimensions of vacuum insulation panel 57 may be selected so that a first side edge 52 of panel 57 may be aligned with a centerline 54 of the first side portion 56 of the refrigerator case 11 and a second side edge 58 of panel 57 may be aligned with a centerline 60 of the second side portion 61 of the refrigerator case 11. Because the side edges 52, 58 of panel 57 are aligned with the centerlines of the side portions 56, 61 of the refrigerator case, the area within the chamber 55 proximate first side edge 52 may generally include sections of back portion 59 as well as of first side portion 56. Thus, the area proximate first side edge 52 may include an additional amount of insulation compared to other areas of the chamber 55 that encompass only back portion 59 or only one of the side portions 56, 61. Similarly, the area proximate second side edge 58 may include an additional amount of insulation compared to other areas of the chamber 55 that encompass only back portion 59 or only one of the side portions 56, 61. As a result, the areas within chamber 55 proximate each of the first and second side edges 52, 58 may hold a maximum volume of insulation compared to other areas of the chamber. Similar to the embodiments shown in FIGS. 4A and 4B, the maximum volumes among the proximate areas may vary due to manufacturing tolerances, assembly tolerances, and other factors.

As referred to above, placing the vacuum insulation panel 57 in the chamber 55 and surrounding it with insulation 21 may result in greatly reducing the thermal conductivity of the back portion 59 of the case 11. Furthermore, selecting the dimensions and location of the vacuum insulation panel 57 so that the side edges 52 and 58 are aligned with the centerlines of the side portions 56 and 61, respectively, and thus are located in areas of the cavity having a substantially maximum volume of insulation, may further enhance the thermal characteristics of back portion 59 by utilizing areas of the chamber 55 with larger volumes of insulation 21 to minimize any edge effects.

FIG. 6 shows a front cross section view of the refrigerator case 11 and illustrates an exemplary embodiment where vacuum insulation panels may be disposed in the refrigerator walls 50, embodied as side portions of the refrigerator case 11. As described above, the refrigerator case 11 includes the outer shell 51 and the inner liner 53 forming the chamber 55. In this embodiment, vacuum insulation panels 62, 63, 64, 65 are located in first side portion 56, a top side portion 66, second side portion 61, and a mullion portion 67, respectively. Furthermore, each panel is located in a side portion of the case 11 so that its edges are positioned in areas of the cavity having a substantially maximum volume of insulation. In this embodiment, the edges are aligned with the centerlines of adjacent side portions of the case 11. As with the other embodiments, because the side edges of each of the panels 62, 63, 64, 65 are aligned with the centerlines of the adjacent side portions 56, 61, 66 and mullion 67 of the refrigerator case, the areas within the chamber 55 proximate each of the side edges of panels 62, 63, 64, 65 may generally include sections of more than one portion of the refrigerator case 51. For example, the areas proximate each of the side edges may include sections from two side portions of the refrigerator case, or a side portion and the mullion portion. As a result, the areas proximate each of the side edges may include additional insulation when compared to other areas of the chamber 55 that encompass only a side or mullion portion. The areas proximate each of the side edges may hold a maximum volume of insulation compared to other areas of the chamber that may include only a side or mullion portion.

Thus, while there have been shown and described and pointed out fundamental novel features of the invention as applied to the exemplary embodiments thereof, it will be understood that various omissions and substitutions and changes in the form and details of devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A refrigerator wall comprising:
an outer shell;
an inner liner;
a cavity formed by the outer shell and the inner liner;
insulation filling the cavity; and
a vacuum insulation panel positioned in the cavity such that at least one edge of the vacuum insulation panel is located in a substantially maximum volume of the insulation.

2. The refrigerator wall of claim 1, further comprising:
a first portion in which the vacuum insulation panel is positioned; and
a side portion extending perpendicular to the first portion,
wherein the at least one edge of the vacuum insulation panel is located on a centerline of the side portion.

3. The refrigerator wall of claim 2, wherein an intersection of the at least one vacuum insulation panel edge and the centerline of the side portion defines a center of an area having the substantially maximum volume of insulation.

4. A refrigerator door comprising:
an outer door member;
an inner door member;
a cavity formed by the outer and inner door members and filled with insulation; and
a vacuum insulation panel positioned in the cavity with its edges located in areas of the cavity having a substantially maximum volume of the insulation.

5. The refrigerator door of claim 4, further comprising:
dike portions circumscribing the inner door member and extending outward from the inner door member, wherein the edges of the vacuum insulation panel align with centerlines of the dike portions.

6. The refrigerator door of claim 5, wherein intersections of the vacuum insulation panel edges and the centerlines of the dike portions define centers of the areas having the substantially maximum volume of insulation.

7. A refrigerator comprising:
a wall having an outer shell and an inner liner;
a cavity formed by the outer shell and the inner liner;
insulation filling the cavity; and
a vacuum insulation panel positioned in the cavity such that at least one edge of the vacuum insulation panel is located in a substantially maximum volume of the insulation.

8. The refrigerator of claim 7, further comprising:
a compartment having an access opening; and
a door for closing the access opening of the compartment, the door comprising:
an outer door member and an inner door member;
a cavity formed by the outer and inner door members;
insulation filling the cavity; and
a second vacuum insulation panel positioned in the cavity with its edges located in areas of the cavity having a substantially maximum volume of the insulation.

9. The refrigerator of claim 8, wherein the door further comprises:
dike portions circumscribing the inner door member and extending outward from the inner door member, wherein the edges of the second vacuum insulation panel are centered between the dike portions.

10. The refrigerator of claim 9, wherein intersections of the second vacuum insulation panel edges and centerlines of the dike portions define centers of the areas having the substantially maximum volume of insulation.

11. A method of manufacturing a refrigerator wall, comprising:
forming a cavity from an outer shell and an inner liner;
placing a vacuum insulation panel within the cavity; and
filling the cavity with insulation,
wherein the vacuum insulation panel is placed within the cavity so that edges of the vacuum insulation panel are surrounded by a maximum volume of insulation.
